(19) United States
(12) Patent Application Publication
(10) Pub. No.: US 2026/0019422 A1
(43) Pub. Date: Jan. 15, 2026

(54) SYSTEMS AND METHODS FOR STREAMLINING AUTOMATED ACCOUNT ACCESS AND SET-UP USING RULE-BASED SECURITY IDENTIFICATION

(71) Applicant: CVS Pharmacy, Inc., Woonsocket, RI (US)

(72) Inventors: Srinivas Loke, Woonsocket, RI (US); Laura N. Klein, Woonsocket, RI (US); Ramesh R. Gidde, Woonsocket, RI (US)

(21) Appl. No.: 19/266,450

(22) Filed: Jul. 11, 2025

Related U.S. Application Data
(60) Provisional application No. 63/670,252, filed on Jul. 12, 2024.

(51) Int. Cl. H04L 9/40

(52) U.S. Cl. CPC H04L 63/102; H04L 63/1433

(57) ABSTRACT

A method is provided. The method comprises: receiving user information comprising one or more identifiers associated with a user, wherein the one or more identifiers indicates a phone number associated with a user device; based on the user information, querying an internal data management system and an external data management system to determine previous interactions of the user; determining one or more calculated risk metrics associated with the user based on comparing the first previous interactions and the second previous interactions with one or more thresholds; generating a dynamic identity data request for the user based on the one or more calculated risk metrics; in response to providing the dynamic identity request to the user device, receiving, from the user device, dynamic identity data for the user; based on the dynamic identity data, authorizing the user access to one or more services.

### CROSS-REFERENCE TO RELATED APPLICATIONS

This patent application claims the benefit of U.S. Provisional Patent Application No. 63/670,252, filed Jul. 12, 2024, which is incorporated by reference herein.

### BACKGROUND

In order to access and interact with their own user information that is being held by an enterprise organization, the user may be required to create one or more digital accounts. Further, to secure access to their digital account, the user may be requested to store personal information such as passwords, date of birth, phone number, and/or other secure information with the enterprise organization. The user may also be asked to go through additional security steps to set-up a passkey and or biometric authentication to access their digital account. The enterprise organization may have a legal obligation to secure the user's digital account as well as verify the passwords, passkeys, and/or biometrics in order to provide authentication and/or access to the user account.

However, the enterprise organization may provide multiple different services and thus may already have received information associated with the user (e.g., information indicating previous interactions with the user). In addition, the enterprise organization may be in communication with other third party entities that may have had previous interactions with the user. Therefore, instead of requesting the user to provide personal information to the enterprise organization, it may be desirable to use the previous user interactions with the enterprise organization and/or the third party entities instead to authorize the user. Accordingly, there remains a technical need to provide access to services provided by the enterprise organization without requiring the user to set up a digital account.

### SUMMARY

In some examples, the present application uses rule-based security identification to provide enriched dynamic grants of access to one or more services provided by an enterprise organization. For instance, the enterprise organization may provide multiple services and the user may seek access to one or more of these services. In some instances, this service may be associated with a storefront (e.g., retail storefront) owned, managed, and/or operated by the enterprise organization. For instance, the retail storefront may have a software application that requires user sign-up prior to accessing features and/or services of the software application (e.g., features and/or services such as allowing the user to access health information to influence and/or modify health behaviors). In some examples, the features may include, but are not limited to, providing the user with promotions (e.g., coupons), facilitating pick-up services (e.g., grocery pick-up and/or prescription pick-up services such as the ability to fill prescriptions) for the user, ability to view health plan spending and deductibles for the user, and/or ability to check drug price and/or mail order prescriptions. To access these features, the user may have to set-up a digital account. However, the user may have previous interactions with the enterprise organization such as interacting with an insurance service provided by the enterprise organization.

Therefore, an enterprise computing platform may obtain information associated with the user and use a rule-based security identification to create an account and use the created account to grant access to the service. For instance, using a mobile one-time password (OTP) and a second factor that is based on the rule-based security identification that is provided by the rules server, the rules server may grant access to the service. In some instances, instead of using a mobile OTP, a mobile wallet may be used as a first factor authentication. For instance, the mobile wallet may include a government issued identification such as a driver's license and/or passport. In some examples, the rules server may generate a dynamic identity data request based on user information from the user (e.g., the OTP and/or a mobile number associated with the user device) and data management system information associated with the user (e.g., previous interactions between the user and the enterprise organization). The dynamic identity data request may be customized for each individual user as each user may have different previous interactions with the enterprise organization. Based on receiving the dynamic identity data from the user, the enterprise computing platform may grant access to the service provided by the enterprise organization. This is described in further detail below.

In one aspect, a method is provided. The method comprises: receiving, from a user device, user information comprising one or more identifiers associated with a user, wherein the one or more identifiers indicates a phone number associated with the user device; based on the user information, querying an internal data management system to determine first previous interactions between an enterprise organization and the user; based on the user information, querying an external data management system to determine second previous interactions between a third party and the user; determining one or more calculated risk metrics associated with the user based on comparing the first previous interactions and the second previous interactions with one or more thresholds; generating a dynamic identity data request for the user based on the one or more calculated risk metrics; in response to providing the dynamic identity data request to the user device, receiving, from the user device, dynamic identity data for the user; based on the dynamic identity data, creating a data structure for a new digital account for the user; populating a plurality of entries for the user within the created data structure based on the user information and the one or more calculated risk metrics, wherein a first entry, of the plurality of entries, indicates a level for the user that is based on the one or more calculated risk metrics; and authorizing the user access to one or more services based on the level for the user that is within the created data structure.

Examples may include one of the following features, or any combination thereof. For instance, in some examples, querying the internal data management system to determine the first previous interactions between the enterprise organization and the user comprises: providing a query to the internal data management system, wherein the query indicates the user information associated with the user; and in response to providing the query, receiving, from the internal data management system, data management system information indicating the first previous interactions between the enterprise organization and the user.

In some instances, querying the external data management system to determine the second previous interactions between the third party and the user comprises: providing a query to the external data management system, wherein the query indicates the user information associated with the user; and in response to providing the query, receiving, from the external data management system, data management system information indicating the second previous interactions between the third party and the user.

In some examples, determining the one or more calculated risk metrics comprises: aggregating the first previous interactions and the second previous interactions to determine aggregated interactions of the user; and comparing the aggregated interactions of the user with the one or more thresholds to determine a risk profile for the user, wherein generating the dynamic identity data request is based on the determined risk profile.

In some variations, aggregating the first previous interactions and the second previous interactions comprises: applying one or more weights to the first previous interactions and the second previous interactions; and determining the aggregated interactions of the user based on applying the one or more weights.

In some instances, the first previous interactions are associated with a prescription pick-up interaction and the second previous interactions are associated with a financial interaction, and wherein applying the one or more weights comprises applying a first weight to the first previous interactions and a second weight to the second previous interactions, wherein the first weight and the second weight are different.

In some examples, determining the one or more calculated risk metrics comprises: determining current interaction characteristics based on the user information; and determining a risk profile for the user based on the current interaction characteristics and comparing the first previous interactions and the second previous interactions with the one or more thresholds, and wherein generating the dynamic identity data request is based on the risk profile.

In some variations, determining the current interaction characteristics comprises: determining a geolocation of the user device based on the user information; and determining whether the geolocation of the user device is in a trusted area, and wherein determining the risk profile for the user is based on whether the geolocation of the user device is in the trusted area.

In some instances, determining the current interaction characteristics comprises: based on the user information, determining whether the user device and/or the user is on a violator list or a risk profile list, and wherein determining the risk profile for the user is based on whether the user device and/or the user is on the violator list or the risk profile list.

In some examples, the one or more calculated risk metrics indicates a first risk profile, and wherein generating the dynamic identity data request comprises: based on the first risk profile, generating the dynamic identity data request requesting for a prescription number and store number of a previously filled prescription for the user, wherein the dynamic identity data for the user indicates the prescription number and the store number, and wherein granting the user access to the one or more services comprises granting the user the ability to fill prescriptions based on the prescription number and the store number indicated by the dynamic identity data.

In some variations, the one or more calculated risk metrics indicates a first risk profile, and wherein generating the dynamic identity data request comprises: based on the first risk profile, generating the dynamic identity data request requesting for an insurance card number of the user and a date-of-birth of the user, wherein the dynamic identity data for the user indicates the insurance card number and the date-of-birth, and wherein granting the user access to the one or more services comprises granting the user the ability to check a drug price and mail order prescriptions based on the insurance card number and the date-of-birth indicated by the dynamic identity data.

In some instances, the one or more calculated risk metrics indicates a first risk profile, and wherein generating the dynamic identity data request comprises: based on the first risk profile, generating the dynamic identity data request requesting for a health plan identifier of the user and a date-of-birth of the user, wherein the dynamic identity data for the user indicates the health plan identifier and the date-of-birth, and wherein granting the user access to the one or more services comprises granting the user the ability to view health plan spending and deductibles based on the health plan identifier and the date-of-birth indicated by the dynamic identity data.

In some examples, the one or more calculated risk metrics indicates a first risk profile, and wherein generating the dynamic identity data request comprises: based on the first risk profile, generating the dynamic identity data request requesting for a first and last name of the user and a date-of-birth of the user, wherein the dynamic identity data for the user indicates the first and last name and the date-of-birth, and wherein granting the user access to the one or more services comprises granting the user the ability to place a mobile order based on the first and last name and the date-of-birth indicated by the dynamic identity data.

In another aspect, an enterprise computing platform comprising one or more processors and a non-transitory computer-readable medium having processor-executable instructions stored thereon is provided. The processor-executable instructions, when executed by the one or more processors, facilitate: receiving, from a user device, user information comprising one or more identifiers associated with a user, wherein the one or more identifiers indicates a phone number associated with the user device; based on the user information, querying an internal data management system to determine first previous interactions between an enterprise organization and the user; based on the user information, querying an external data management system to determine second previous interactions between a third party and the user; determining one or more calculated risk metrics associated with the user based on comparing the first previous interactions and the second previous interactions with one or more thresholds; generating a dynamic identity data request for the user based on the one or more calculated risk metrics; in response to providing the dynamic identity data request to the user device, receiving, from the user device, dynamic identity data for the user; based on the dynamic identity data, creating a data structure for a new digital account for the user; populating a plurality of entries for the user within the created data structure based on the user information and the one or more calculated risk metrics, wherein a first entry, of the plurality of entries, indicates a level for the user that is based on the one or more calculated risk metrics; and authorizing the user access to one or more services based on the level for the user that is within the created data structure.

Examples may include one of the following features, or any combination thereof. For instance, in some examples, querying the internal data management system to determine the first previous interactions between the enterprise organization and the user comprises: providing a query to the internal data management system, wherein the query indicates the user information associated with the user; and in response to providing the query, receiving, from the internal data management system, data management system information indicating the first previous interactions between the enterprise organization and the user.

In some instances, querying the external data management system to determine the second previous interactions between the third party and the user comprises: providing a query to the external data management system, wherein the query indicates the user information associated with the user; and in response to providing the query, receiving, from the external data management system, data management system information indicating the second previous interactions between the third party and the user.

In some examples, determining the one or more calculated risk metrics comprises: aggregating the first previous interactions and the second previous interactions to determine aggregated interactions of the user; and comparing the aggregated interactions of the user with the one or more thresholds to determine a risk profile for the user, wherein generating the dynamic identity data request is based on the determined risk profile.

In some variations, aggregating the first previous interactions and the second previous interactions comprises: applying one or more weights to the first previous interactions and the second previous interactions; and determining the aggregated interactions of the user based on applying the one or more weights.

In some instances, the first previous interactions are associated with a prescription pick-up interaction and the second previous interactions are associated with a financial interaction, and wherein applying the one or more weights comprises applying a first weight to the first previous interactions and a second weight to the second previous interactions, wherein the first weight and the second weight are different.

In yet another aspect, a non-transitory computer-readable medium having processor-executable instructions stored thereon is provided. The processor-executable instructions, when executed by the one or more processors, facilitate: receiving, from a user device, user information comprising one or more identifiers associated with a user, wherein the one or more identifiers indicates a phone number associated with the user device; based on the user information, querying an internal data management system to determine first previous interactions between an enterprise organization and the user; based on the user information, querying an external data management system to determine second previous interactions between a third party and the user; determining one or more calculated risk metrics associated with the user based on comparing the first previous interactions and the second previous interactions with one or more thresholds; generating a dynamic identity data request for the user based on the one or more calculated risk metrics; in response to providing the dynamic identity data request to the user device, receiving, from the user device, dynamic identity data for the user; based on the dynamic identity data, creating a data structure for a new digital account for the user; populating a plurality of entries for the user within the created data structure based on the user information and the one or more calculated risk metrics, wherein a first entry, of the plurality of entries, indicates a level for the user that is based on the one or more calculated risk metrics; and authorizing the user access to one or more services based on the level for the user that is within the created data structure.

All examples and features mentioned above may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3 is an exemplary process for using rule-based security identification in accordance with one or more examples of the present application.

FIGS. 4A and 4B show an exemplary event sequence for using rule-based security identification in accordance with one or more examples of the present application.

FIG. 5 shows another exemplary event sequence for using rule-based security identification in accordance with one or more examples of the present application.

FIG. 6 shows exemplary scenarios of using the rule-based security identification in accordance with one or more examples of the present application.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Systems, methods, and computer program products are herein disclosed that use rule-based security identification to create digital accounts for a user and use the created digital accounts to grant access to one or more services provided by an enterprise organization. In some examples, aspects described herein may decrease user friction. For instance, setting up digital accounts may be cumbersome for the user, and many users may abandon the process. As such, aspects described herein may leverage information from previous interactions such that the user might not need to “start from the beginning” and re-enter all of their personal information that is already known to the enterprise organization. Additionally, and/or alternatively, aspects described herein may also be beneficial to the enterprise organization as manual information associated with the user might not need to be entered by the enterprise organization, which may help avoid typographical errors and so forth. This will be described in further detail below.

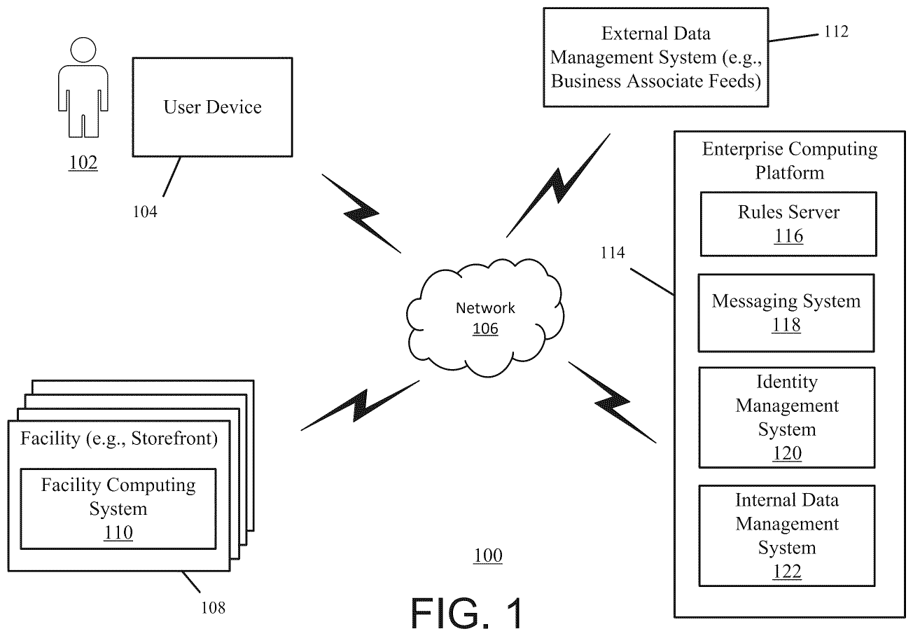

FIG. 1 is a simplified block diagram depicting an exemplary environment in accordance with an example of the present application. The environment 100 includes a user 102, a user device 104, a network 106, one or more facilities 108 (e.g., storefronts), an external data management system 112, and an enterprise computing platform 114. The facilities 108 include facility computing systems 110. The enterprise computing platform 114 includes a rules server 116, a messaging system 118, an identity management system 120, and an internal data management system 122. Although the entities within environment 100 may be described below and/or depicted in the FIGs. as being singular entities, it will be appreciated that the entities and functionalities discussed herein may be implemented by and/or include one or more entities.

The entities within the environment 100 such as the user device 104, the facility computing systems 110, the external data management system 112, and/or the enterprise computing platform 114 may be in communication with other systems or facilities within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100. In some instances, one or more entities within the environment 100 may communicate with each other without using the network 106 (e.g., via communication protocols such as WI-FI or BLUETOOTH or via wired connections). In some examples, aspects of the enterprise computing platform 114 may communicate with other aspects of the enterprise computing platform 114 using the network 106. For instance, one or more of the aspects of the enterprise computing platform 114 (e.g., the rules server 116, the messaging system 118, the identity management system 120, and/or the internal data management system 122) may be located in different geographical areas, and may thus communicate with other aspects of the enterprise computing platform 114 using the network 106.

User 102 may operate, own, and/or otherwise be associated with the user device 104. For instance, the user 102 may be located in a particular location and may use the user device 104 to access content from particular applications and/or services associated with an enterprise organization. The applications may be any type of software application or program that provides one or more services such as web-based applications, mobile applications, web-browser applications, and/or other types of applications or programs that the user 102 may access using the user device 104. Additionally, and/or alternatively, the user 102 may be at a facility 108 associated with an enterprise organization and may use the user device 104 to communicate with a facility computing system 110 such as sign-up for a service provided by the enterprise organization.

The user device 104 is and/or includes, but is not limited to, a desktop, laptop, tablet, mobile device (e.g., smartphone device, or other mobile device), smart watch, an internet of things (IoT) device, or any other type of computing device that generally comprises one or more communication components, one or more processing components, and one or more memory components. The user device 104 may be able to execute software applications and/or programs associated with the enterprise organization. Additionally, and/or alternatively, the user device 104 may be configured to operate a web browser to connect to a web page and/or applications hosted and/or managed by systems.

The plurality of facilities 108 may be owned, operated, and/or otherwise associated with the enterprise organization. The enterprise organization may be any type of corporation, company, organization, and/or other institution. In some instances, the enterprise organization may own, operate, and/or be otherwise associated with one or more facilities 108 (e.g., physical storefronts) and/or distribution centers. For instance, the enterprise organization may operate physical storefronts that sell a plurality of products (e.g., toothbrush, toothpaste, and so on). Additionally, and/or alternatively, the enterprise organization may be associated with a medical provider and/or insurance provider. For example, the enterprise organization may receive pharmaceutical prescriptions from a medical provider, and may provide medications indicated by the prescriptions to users. In other words, the enterprise organization may manage and/or own a pharmacy that sells physical products and/or provides prescriptions to users. Furthermore, in some examples, the enterprise organization may provide insurance services to the users.

The facilities 108 may be and/or include the physical storefronts that are owned, operated, and/or otherwise associated with the enterprise organization. The facilities 108 include facility computing systems 110. The facility computing systems 110 may be in communication with the user device 104 and/or the enterprise computing platform 114. For instance, the facility computing systems 110 may provide information from the user device 104 to the enterprise computing platforms 114 (e.g., the identity management system 120 and/or the rules server 116). Additionally, and/or alternatively, the facility computing systems 110 may receive information (e.g., instructions such as indicating authorization of the user 102) from the enterprise computing platform 114. For instance, the facility computing systems 110 may receive information indicating that a prescription pick-up and/or an online grocery pick-up from the user device 104 and/or the user 102. In some examples, the facility computing systems 110 may be and/or include check-out systems that facilitate financial transactions (e.g., retail and/or pharmaceutical financial transactions) between the user 102 and an employee of the enterprise organization.

The facility computing system 110 may be and/or include, but is not limited to, a desktop, laptop, tablet, mobile device (e.g., smartphone device, or other mobile device), smart watch, an internet of things (IoT) device, or any other type of computing device that generally comprises one or more communication components, one or more processing components, and one or more memory components. The facility computing system 110 may be able to execute software applications managed by, in communication with, and/or otherwise associated with the enterprise organization. Additionally, and/or alternatively, the facility computing system 110 may be configured to perform other functions.

The external data management system 112 may be owned, operated, and/or managed by a third party that is separate from the enterprise organization. For example, the external data management system 112 may be a data management system that obtains information associated with the user 102 such as information indicating previous interactions between the user 102 and the third party. The external data management system 112 may be associated with the enterprise organization such as being a business associate that provides information associated with the user 102. For instance, the external data management system 112 may store information (e.g., data management system information) about multiple different users that use services provided by the third party (e.g., financial services). The external data management system 112 may provide data management system information to the enterprise computing platform 114, and in some instances, the data management system information may indicate previous interactions between the users and the third party.

The external data management system 112 includes one or more computing devices, computing platforms, cloud computing platforms, systems, servers, and/or other apparatuses capable of performing tasks, functions, and/or other actions. In some variations, the external data management system 112 may be implemented as engines, software functions, and/or applications. In other words, functionalities of the external data management system 112 may be implemented as software instructions stored in storage (e.g., memory) and executed by one or more processors.

The enterprise computing platform 114 is a computing platform that is associated with the enterprise organization. For example, the enterprise organization may provide multiple different services to users, including the user 102, such as a grocery service, pharmacy service, retail service, insurance service, and/or other services. In order for users to access the services, a digital account set-up and log-in may be used. Given the previous interactions of the user 102 and instead of forcing the user 102 to sign-up for a digital account for one or more of the services, the enterprise computing platform 114 may use a rules-based security identification and authorization to create an account for the user 102 and then grant access to the user 102 to the provided services. For example, based on previous interactions of the user 102, the enterprise computing platform 114 may generate a dynamic identity request that requests particular fields of information from the user 102. Based on the dynamic identity data from the user device 104, the enterprise computing platform 114 may grant the user 102 access to the requested service. By using the dynamic identity data request, this may solve the need to create and/or maintain a user digital account and/or provide the user access to their user profile to interact with their customer information held by the enterprise organization and/or the enterprise computing platform 114. Additionally, and/or alternatively, the user might not need to secure their digital account access by storing passwords, passkeys, biometrics, and/or other secure information with the enterprise computing platform 114.

The rules server 116 may use one or more processes, algorithms, and/or methods to perform a rules-based security identification and authorization. The messaging system 118 may provide messages between entities of environment 100. For instance, the messaging system 118 may provide an OTP to the user device 104, and the user device 104 may provide a response to the OTP to the enterprise computing platform 114. The identity management system 120 may manage the identity of the users and/or user devices associated with the enterprise computing platform 114. The internal data management system 122 may function similarly to the external data management system 112. For instance, the internal data management system 122 may store information associated with previous interactions between users and the enterprise organization. The enterprise computing platform 114 as well as the aspects of the computing platform 114 (e.g., the rules server 116, the messaging system 118, the identity management system 120, and the internal data management system 122) will be described in further detail below.

The enterprise computing platform 114 includes one or more computing devices, computing systems, cloud computing platforms, systems, servers, and/or other apparatuses capable of performing tasks, functions, and/or other actions for the enterprise organization. In some examples, the functionalities of each of the rules server 116, the messaging system 118, the identity management system 120, and the internal data management system 122 may be performed by a different computing device and/or system. In other examples, a single computing device and/or system may perform the functionalities of the rules server 116, the messaging system 118, the identity management system 120, and/or the internal data management system 122.

In some variations, the enterprise computing platform 114 and/or aspects of the enterprise computing platform 114 may be implemented as engines, software functions, and/or applications. In other words, functionalities of the enterprise computing platform 114 may be implemented as software instructions stored in storage (e.g., memory) and executed by one or more processors.

It will be appreciated that the exemplary environment depicted in FIG. 1 is merely an example, and that the principles discussed herein may also be applicable to other situations—for example, including other types of institutions, organizations, devices, systems, and network configurations.

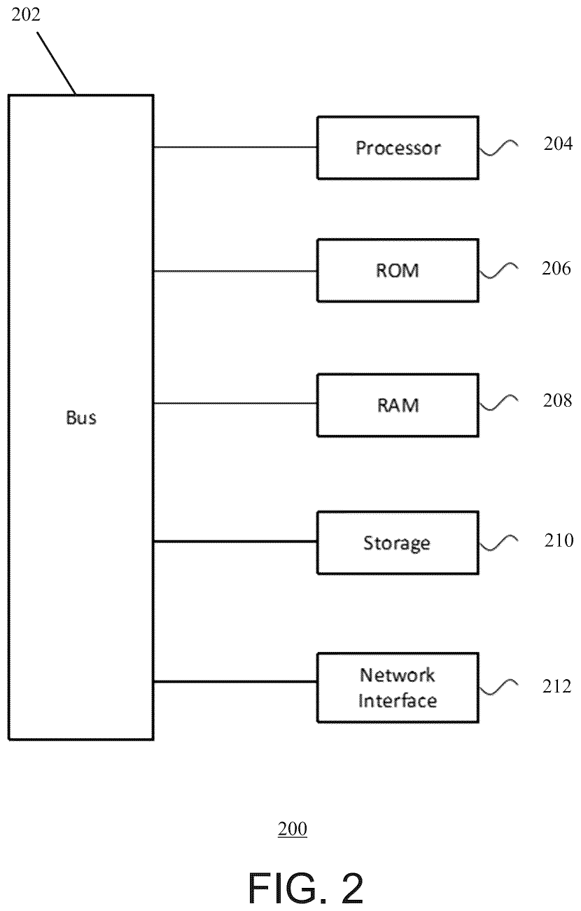

FIG. 2 is a block diagram of an exemplary system and/or device 200 within the environment 100. The device/system 200 includes a processor 204, such as a central processing unit (CPU), controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component within the device/system 200.

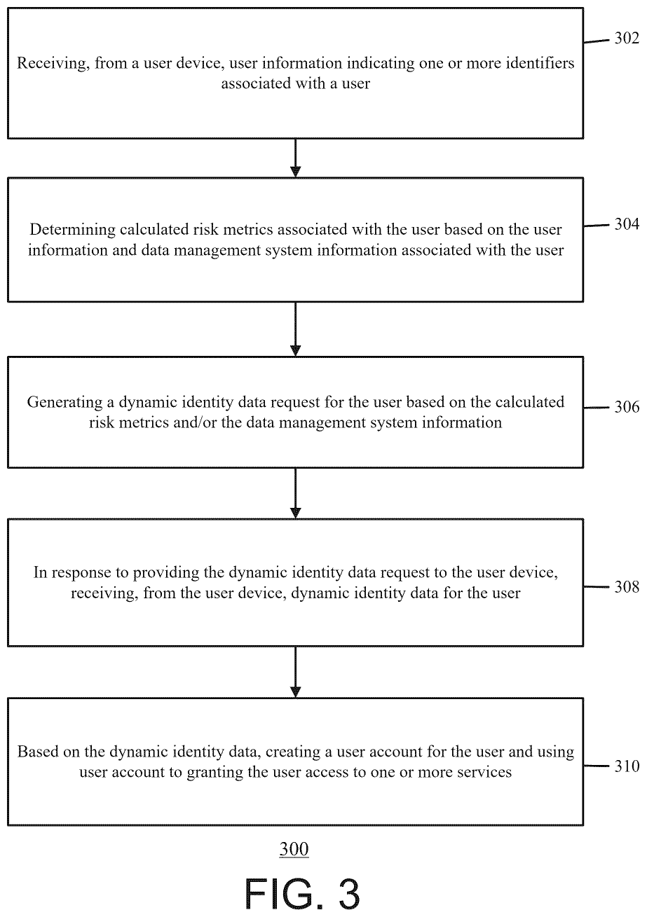

FIG. 3 is an exemplary process for using rule-based security identification in accordance with one or more examples of the present application. The process 300 may be performed by the enterprise computing platform 114 shown in FIG. 1. However, it will be recognized that any of the following blocks may be performed in any suitable order, the blocks may be performed by any suitable system, and that the process 300 may be performed in any suitable environment. The descriptions, illustrations, and processes of FIG. 3 are merely exemplary and the process 300 may use other descriptions, illustrations, and processes.

At block 302, the enterprise computing platform 114 receives, from a user device 104, user information indicating one or more identifiers associated with a user 102. For instance, the identifiers may include and/or indicate a mobile number of the user device 104 and/or another type of identifier associated with the user device 104 and/or the user 102 such as an email address of the user 102 and/or government issued identification (ID) (e.g., driver's license).

For example, in some variations, the user 102 may be at a facility 108 that is associated with the enterprise organization. The user 102 may have an interaction within the facility 108 and may seek to set-up a digital account. For example, the enterprise organization may operate and/or manage a software application that is associated with the facility 108. The software application may provide promotions and/or other features such as grocery pick-up services to the user 102. However, to access these features, the user 102 may have to set-up a digital account. Traditionally, this may be performed by the user 102 providing personal information such as passwords, passkeys, biometrics, and/or other personal information. However, this may cause the enterprise organization to store this personal information, which creates an obligation to secure the user's digital account and verify passwords, passkeys, and/or biometrics to provide authentication and/or access to the user account. For instance, the user 102 may provide the personal information such as biometrics and/or passwords, and the enterprise organization may store this personal information to ensure that the user 102 may log onto this digital account in the future.

Instead of having the user 102 provide personal information to the enterprise computing platform 114 for the account set-up, the enterprise computing platform 114 may request for the user to provide user information such as a mobile number of the user device 104. The user information may be different from the personal information as the user information might not include any personal and/or sensitive information associated with the user 102. Instead, the user information may be and/or include aspects such as a mobile phone number, email address, and/or government issued identification (ID) (e.g., driver's license). As will be described in further detail below, by using the user information (e.g., the mobile number of the user device 104), the user 102 might not be required to provide personal information to the enterprise computing platform 114. Therefore, the enterprise computing platform 114 may grant access to the services (e.g., the services provided by the software application such as the promotions/coupons) without having to authenticate the personal information such as passwords and passkeys, and thus, the enterprise computing platform 114 does not have to store the personal information of the user 102.

In some examples, after receiving the user information, the enterprise computing platform 114 may provide an OTP to the user device 104. The user device 104 may provide a response to the OTP, and the enterprise computing platform 114 may proceed with process 300 based on verifying the response to the OTP. As such, the enterprise computing platform 114 may perform a two factor authentication with the first factor being an OTP and the second factor being a rule-based authentication (e.g., performing blocks 304-308).

At block 304, the enterprise computing platform 114 determines calculated risk metrics associated with the user 102 based on the user information and data management system information associated with the user 102. For example, after receiving the user information (e.g., mobile number), the enterprise computing platform 114 may check for additional information associated with the user 102. For instance, the additional information may be and/or indicate previous interactions that the user 102 had with the enterprise organization and/or the third party. For example, the enterprise computing platform 114 may include an internal data management system 122 that manages internal data. The internal data management system 122 may include and/or be associated with one or more data sources that store information associated with the user 102. For example, the enterprise organization may provide additional services such as prescription pick-up services and/or insurance services. These additional services may have information associated with them, and the information may also indicate the user information of the user. For instance, for an insurance service (e.g., the user 102 may be a member of an insurance plan that is managed by the enterprise organization), the data sources associated with the internal data management system 122 may store information also indicating the user information such as a mobile number of the user 102. Additionally, and/or alternatively, the external data management system 112 may provide another service (e.g., a financial service), and may store information associated with the other service. For instance, the external data management system 112 may also store information indicating the user information such as the mobile number of the user 102.

The enterprise computing platform 114, using the user information, may request data management system information from the internal data management system 122 and/or the external data management system 112. For instance, the enterprise computing platform 114 (e.g., rules server 116) may provide a query for information associated with the user information. The internal data management system 122 and/or the external data management system 112 may respond to the query, and provide the data management system information associated with the user 102. For example, using the user information such as the mobile number of the user device 104, the internal data management system 122 and/or the external data management system 112 may determine previous interactions that the user 102 and/or the user device 104 have had with the enterprise organization and/or the third party (e.g., that the user 102 is a member of an insurance plan that is managed by the enterprise organization and/or the user 102 has a financial account with the third party). Based on the previous interactions, the internal data management system 122 and/or the external data management system 112 may obtain (e.g., retrieve and/or generate) the data management system information indicating the previous interactions, and provide the data management system information to the enterprise computing platform 114.

Based on the user information and/or the data management system information from the internal data management system 122 and/or the external data management system 112, the enterprise computing platform 114 may determine one or more calculated risk metrics. The calculated risk metrics may indicate whether the previous interactions with the user 102 have reached a point to be able to implement the dynamic identity data request. For instance, in some examples, the calculated risk metrics may be a configurable value that is determined based on user prior interaction characteristics (e.g., number of prior interactions with the user 102 and/or the types of the prior interactions), current interaction characteristics (e.g., geographical location data, whether the user device 104 is a known device, known violator profiling), and/or allowed grant types. Further, the calculated risk metrics may indicate and/or be associated with a risk profile such as “high,” “low,” and/or “severe.” For instance, each risk profile may have an associated risk profile threshold and based on the calculated risk metrics meeting one or more of the risk profile thresholds, the enterprise computing platform 114 may determine a risk profile for the user 102. Additionally, and/or alternatively, in other examples, the calculated risk metrics may include two entries—one for the configurable value and another for the risk profile. In other words, the calculated risk metric may indicate the risk profile.

In some examples, based on the data management system information indicating previous interactions, the enterprise computing platform 114 may select between a plurality of different calculated risk metrics. For example, the plurality of calculated risk metrics may indicate “high,” “low,” and/or “severe.” For instance, based on the data management system information indicating no previous interactions with the user 102, the enterprise computing platform 114 may select “severe,” and process 300 may end. Based on the data management system information indicating a few previous interactions with the user 102, the enterprise computing platform 114 may select a “high” risk metric. Further, based on the data management system information indicating a significant amount of previous interactions with the user 102, the enterprise computing platform 114 may select a “low” risk metric. In other words, the different risk metrics may be associated with an amount of previous interactions that the user 102 previously had with the enterprise organization and/or the third party.

Additionally, and/or alternatively, the quality of the previous interactions may impact the determined or selected risk metrics. For example, the enterprise computing platform 114 may apply different weighted values to the different previous interactions. For instance, a first weighted value may be applied to an insurance interaction (e.g., the user 102 is a member of an insurance service provided by the enterprise organization) and a second weighted value may be applied to a financial interaction (e.g., the user 102 has a financial account with the third party). The first weighted value may be greater than the second weighted value as the insurance service is provided by the enterprise organization and not a third party. As such, the enterprise computing platform 114 may select the calculated risk metrics based on the different weighted values. For instance, the user 102 may have a lower risk based on being part of the insurance interaction and thus the enterprise computing platform 114 may select the “low” risk metric for the user 102.

Additionally, and/or alternatively, the enterprise computing platform 114 may use the user information to select between the different calculated risk metrics. For example, the user information may indicate the mobile number and/or additional information associated with the user device 104 and/or the user 102 such as whether the user device 104 is in a violator internet protocol (IP) list and/or risk profile list. Additionally, and/or alternatively, the additional information may indicate a geolocation of the user 102 and/or the user device 104. Based on the geolocation, the enterprise computing platform 114 may determine whether the user device 104 and/or the user 102 is in a trusted location, and may determine the calculated risk metrics based on whether the user device 104 and/or the user 102 is in the trusted location.

At block 306, the enterprise computing platform 114 generates a dynamic identity data request for the user 102 based on the calculated risk metrics and/or the data management system information. For example, based on the previous interactions of the user 102 with the enterprise organization and/or the third party, the enterprise computing platform 114 may generate the dynamic identity data request indicating one or more requested fields of information such as, but not limited to, a date of birth of the user 102 and/or an insurance card number. Additionally, and/or alternatively, the enterprise computing platform 114 may generate the dynamic identity data request based on the calculated risk metrics. For example, the enterprise computing platform 114 may generate different dynamic identity data requests based on different calculated risk metrics (e.g., “High” or “Low” calculated risk metrics). For instance, based on the calculated risk metric being “Low”, the enterprise computing platform 114 may generate a first dynamic identity data request indicating one or more first requested fields such as date of birth. Based on the calculated risk metric being “High”, the enterprise computing platform 114 may generate a second dynamic identity data request indicating one or more second requested fields such as insurance card number and date of birth. In other words, based on a number of previous interactions with the user 102 and/or based on the quality of previous interactions with the user 102, the enterprise computing platform 114 may generate different dynamic identity data requests (e.g., requests that require the user 102 to provide additional information and/or more detailed information).

At block 308, in response to providing the dynamic identity data request to the user device 104, the enterprise computing platform 114 receives, from the user device 104, dynamic identity data for the user 102. For example, after performing block 306, the enterprise computing platform 114 may provide the dynamic identity data request to the user device 104. The user 102, using the user device 104, may provide information that is requested by the dynamic identity data request such as the date of birth of the user 102. The user device 104 may generate the dynamic identity data based on the user input (e.g., date of birth of the user 102), and provide the dynamic identity data to the enterprise computing platform 114.

At block 310, based on the dynamic identity data, the enterprise computing platform 114 creates the user account for the user 102 and uses the user account to grant the user 102 access to one or more services. For example, the enterprise computing platform 114 may compare the dynamic identity data (e.g., date of birth of the user 102) with data from the data management system information (e.g., date of birth of the user 102 that is received from the internal data management system 122 and/or the external data management system 112). Based on the comparison, the enterprise computing platform 114 may grant the user 102 access to the services. For instance, based on the date of birth of the user 102 matching, the enterprise computing platform 114 may provide instructions to grant the user 102 the ability to check the drug price and/or mail order prescriptions.

In other words, using process 300, the enterprise computing platform 114 may grant the user 102 access to one or more services based on a rules-based security identification and authorization. For instance, the user 102 may have previously engaged with trusted assets associated with the enterprise organization (e.g., services being provided by the enterprise organization and/or trusted third parties). For instance, the trusted assets may include, but are not limited to, health plan/in-person interactions at a retail health and/or pharmacy locations (e.g., in-person interactions with a facility computing system 110 within a facility 108). In some examples, the in-person interactions may be previous iterations/performances of process 300 (e.g., the enterprise computing platform 114 and the user device 104 performing an OTP and based on a successful OTP, the enterprise computing platform 114 and/or the user device 104 performing a second factor such as performing blocks 304-308).

Based on the previous interactions/engagements, in a current iteration, the user device 104 may provide the mobile number to the enterprise computing platform 114. Additionally, and/or alternatively, the facility computing system 110 may provide the mobile number of the user device 104 to the enterprise computing platform 114. For instance, the facility computing system 110 may obtain the mobile number of the user device 104 (e.g., via BLUETOOTH or one or more Near-Field Communication (NFC) communication protocols), and provide the mobile number to the enterprise computing platform 114. Additionally, and/or alternatively, the user 102 may provide user input indicating the mobile number to the facility computing system 110, and the facility computing system 110 may provide the mobile number to the enterprise computing platform 114.

The enterprise computing platform 114 may validate possession of the mobile number with OTP, and then validate using a second factor that is provided with the in-store interaction. For example, the enterprise computing platform 114 may perform blocks 304 and 306 described above to derive the second factor (e.g., generate the dynamic identity data request) based on use case for elevated access. After, the enterprise computing platform 114 provides digital access to the user 102 and may connect and/or provide the user device 104 with associated information from the user profile.

By using process 300, the mobile OTP and the second factor may solve the need to create and/or maintain a user digital account. Additionally, and/or alternatively, this may further provide the user 102 access to their digital profile to interact with their user information held by the enterprise organization. Additionally, and/or alternatively, this may cause the user 102 to not need to secure their digital account access by storing passwords, passkeys, biometrics, or the secure information, and may further permit the enterprise organization to secure the customer's profile without needing to store or verify this information to provide authentication and access to the user's information.

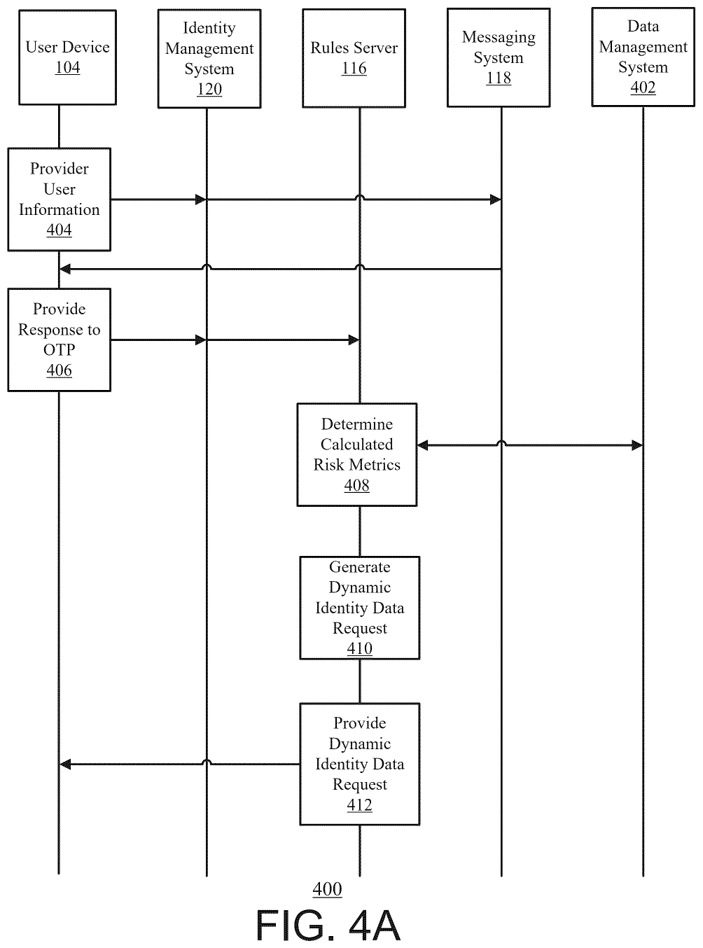

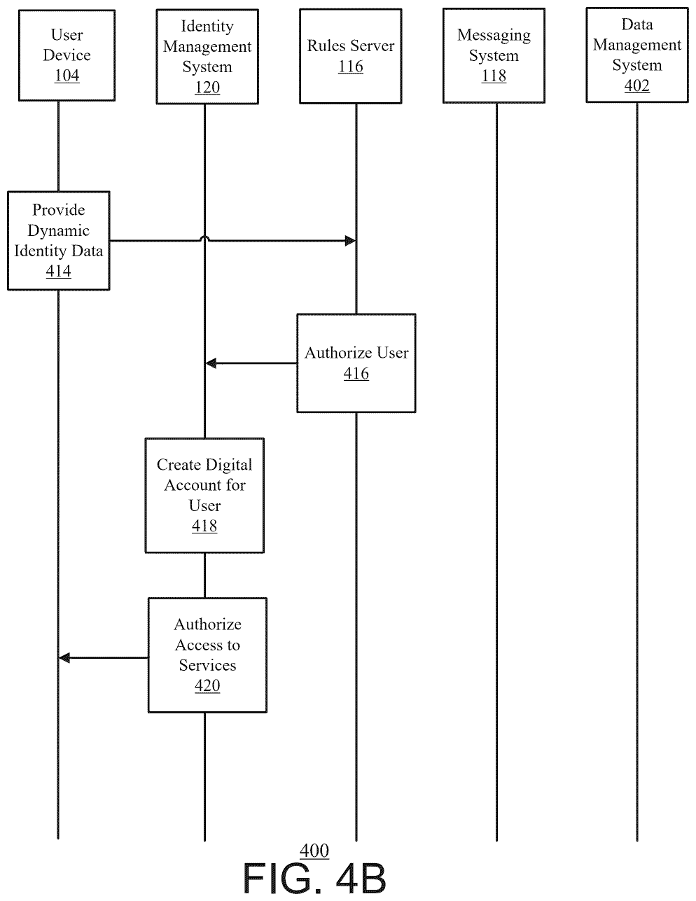

Process 300 will be described in further detail in the context of event sequence 400. FIGS. 4A and 4B show an exemplary event sequence for using rule-based security identification in accordance with one or more examples of the present application. The event sequence 400 includes processes, functions, and/or steps performed by the user device 104, the identity management system 120, the rules server 116, the messaging system 118, and a data management system 402 (e.g., the internal data management system 122 and/or the external data management system 112). For instance, the event sequence 400 describes performance of the two-factor authentication with the first factor using OTP and the second factor using the rules server 116.

In operation, referring to FIG. 4A, at block 404, the user device 104 provides user information to the identity management system 120, and the identity management system 120 forwards this user information to the messaging system 118. For instance, as mentioned previously in block 302, the user information may indicate and/or include a mobile number of the user device 104. The messaging system 118 may perform OTP authentication and provide an OTP to the user device 104.

For example, in some variations, the user 102 may be at a first facility 108 and may seek to purchase one or more products (e.g., retail products such as toothbrushes, toothpastes, and so on and/or pharmaceutical products such as prescription medication). The user 102 may interact with an employee (e.g., a store clerk) at the first facility 108 and the employee may provide the user 102 with incentives to sign-up for a digital account. For instance, the digital account may allow the user 102 to access promotions and/or marketing campaigns. Traditionally, to sign-up for the account, the user 102 may use the user device 104 to manually provide a username, password, and/or biometrics. However, as mentioned above, by storing the personal information of the user 102, this may create an obligation to secure a digital account, which even through the best security interventions, may be vulnerable to attack by unauthorized entities. As such, instead of requesting the user device 104 to manually provide usernames, passwords, and/or biometrics, the user device 104 may provide less vulnerable user information such as a mobile number of the user device 104 and/or a government issued ID (e.g., a driver's license). The user device 104 may provide the user information to the enterprise computing platform 114 (e.g., the identity management system 120). Subsequently, the enterprise computing platform 114 (e.g., the messaging system 118) may provide an OTP to the user device 104.

At block 406, the user device 104 provides a response to the OTP to the identity management system 120, and the identity management system 120 provides the response to the rules server 116. For example, the user device 104 may provide a response to the OTP and the identity management system 120 may compare the response with the original OTP that was passed to the user device 104. Based on the comparison (e.g., that the response from the user device 104 matches the original OTP), the identity management system 120 may determine the user device 104 is authenticated and may provide the indicated authentication to the rules server 116.

At block 408 and based on the authentication, the rules server 116 determines the calculated risk metrics based on communications with the data management system 402. This is described above in block 304. For example, the rules server 116 may obtain two sets of information—a first set of information from the internal data management system 122 and a second set of information from the external data management system 112. The rules server 116 may determine the calculated risk metrics based on the two sets of information. For instance, in some variations, the rules server 116 may provide a prompt to the internal data management system 122 and the external data management system 112. The prompt may include the user information (e.g., the mobile number and/or the government issued ID) and a request for previous interactions with the user 102 based on the user information. For instance, the internal data management system 122 may store prescription information associated with the user 102 (e.g., prescriptions that the user 102 has previously picked up from one or more of the facilities 108). The prescription information may indicate user information such as a phone number. Based on the prompt, the internal data management system 122 may search through its databases to identify a number of times that the user information was recorded. For example, during each prescription pick-up, the pharmacist or technician may request the user 102 to provide their mobile number. For each prescription pick-up, the mobile number of the user 102 may be stored within a database associated with the internal data management system 122. Based on the prompt, the internal data management system 122 may search through its databases to identify a number of times that the user 102 used the mobile number to pick-up a prescription.

In other examples, the user 102 may have provided other types of user information in other scenarios such as the user 102 providing their government issued ID to purchase age-restricted items. As such, based on the searching, the internal data management system 122 may generate the first set of information indicating a number of times that the user 102 interacted with the internal data management system 122 previously, and provide the first set of information back to the rules server 116.

Similarly, the user 102 may have previously interacted with the external data management system 112. For instance, the external data management system 112 may be associated with a financial institution such as a banking system. The user 102 may provide their user information (e.g., mobile phone or government issued ID) along with other information in order to interact with the financial institution (e.g., withdraw monetary assets from the banking system). The external data management system 112 may store information indicating these interactions within its database. Based on the prompt, the external data management system 112 may provide the second set of information indicating a number of these interactions.

After obtaining the first and second sets of information from the internal data management system 122 and the external data management system 112, the rules server 116 may determine the calculated risk metrics. For example, the calculated risk metrics may include a plurality of risk profiles such as a “high” risk profile and a “low” risk profile, and each of the risk profiles may be associated with a threshold. For instance, the rules server 116 may determine the aggregated interactions of the user within the first and second sets of information, and may then compare the aggregated interactions with one or more thresholds. Based on the comparison, the rules server 116 may determine whether the user 102 belongs to the “high” risk profile or the “low” risk profile. In other words, if the user 102 has previously interacted with both the internal data management system 122 (e.g., based on picking up a number of prescriptions) and the external data management system 112 (e.g., based on performing a number of financial interactions) a number of times (e.g., more than 100 times), the rules server 116 may determine the user 102 belongs to the “low” risk profile. Based on the user 102 having previously interacted with both the internal data management system 122 and the external data management system 112 less than a number of times (e.g., less than 20 times), the rules server 116 may determine the user 102 belongs to the “high” risk profile.

Additionally, and/or alternatively, rather than using purely the number of previous interactions, the rules server 116 may weigh the interactions differently depending upon the type of interaction. For example, the rules server 116 may apply a first weight to the financial interaction with the external data management system 112 and a second weight to the prescription pick-up interaction. After the weighting, the rules server 116 may compare the weighted values with the one or more thresholds to determine the risk profile.

At block 410, the rules server 116 generates a dynamic identity data request. This is described above in block 306. For instance, based on the calculated risk metrics (e.g., the determined risk profile), the rules server 116 may generate the dynamic identity data request. In some examples, in addition to the calculated risk metrics, the rules server 116 may generate the dynamic identity data request based on the user information. In other words, in addition to the personal information of the user 102, the user information may further indicate specific services that the user 102 would like to access and the rules server 116 may generate the dynamic identity data request based on the specific services. For instance, in the example above, the employee may provide the user 102 with incentives (e.g., promotions and/or marketing campaigns) to sign-up for the digital account. In other examples, the user 102 may seek to sign-up for the digital account to fill a prescription. As such, the user 102 may provide the user information indicating the reasoning behind their desire to sign-up for the digital account.

The rules server 116 may use the user information and/or the determined risk profile to generate the dynamic identity data request. For example, for less sensitive services (e.g., signing up to access promotions and/or marketing campaigns), the generated dynamic identity data request may request less sensitive information from the user 102. For instance, for less sensitive services and for a “low” risk profile (e.g., based on a significant number of previous interactions), the generated dynamic identity data request may indicate for the user 102 to provide their date-of-birth (DOB). Even for a “high” risk profile, the generated dynamic identity data request may indicate for the user 102 to provide more information than purely their DOB, but not too sensitive of information (e.g., their DOB and their first and last name). However, for more sensitive services (e.g., signing up to fill a prescription), the generated dynamic identity data request may request for more sensitive information for both the “low” risk profile and/or the “high “risk” profile. For instance, for the “low” risk profile, the generated dynamic identity data request may request the same information as the less sensitive services, and may merely request the DOB of the user 102. But, for the “high” risk profile, the generated dynamic identity data request may request more sensitive information such as a prescription (Rx) number and/or store number.

At block 412, the rules server 116 provides the dynamic identity data request to the user device 104. For instance, the rules server 116 may provide a request to the user device 104 to provide certain information associated with the user 102 such as the date of birth of the user 102 and/or other information.

Referring to FIG. 4B, at block 414, the user device 104 provides the dynamic identity data. For instance, the user 102 may provide user input indicating the dynamic identity data (e.g., the DOB of the user 102), and the user device 104 may provide the dynamic identity data to the rules server 116.

At block 416, the rules server 116 may authorize the user 102. For example, based on a comparison of the dynamic identity data and information from the data management system 402, the rules server 116 may determine whether to provide authentication to the user 102. For example, when communicating with the data management system 402 at block 408, the rule server 116 may obtain information from the user 102 such as the DOB of the user 102. The rules server 116 may compare the obtained information (e.g., the DOB) with the dynamic identity data (e.g., user input indicating the DOB). Based on the dynamic identity data matching the obtained information from the data management system 402, the rules server 116 may determine to authenticate the user 102 and provide the authentication to the identity management system 120.

At block 418, the identity management system 120 creates a digital account for the user. For example, based on the authentication indication from the rules server 116, the identity management system 120 may create a digital account for the user 102 based on the user information and/or the obtained information. For instance, the identity management system 120 may include and/or be associated with a database that stores digital account information for users. The digital account information may be in a data structure format (e.g., an array) that includes a plurality of entries including the identity of the user 102 and/or other information of the user 102 (e.g., the DOB of the user 102). In addition, the digital account information may include levels for the user 102 (e.g., privilege levels, assurance levels, and/or levels of assurance). The levels may indicate the level of service that the user 102 may be allowed to access. For instance, at an initial level, the user 102 may be able to receive digital promotions and/or marketing campaigns. At a more advanced level, the user 102 may be able to use their user device 104 to fill prescriptions and/or pick-up retail products (e.g., groceries). Thus, in an initial iteration of process 300 and/or event sequence 400 (e.g., based on generating the dynamic identity data request and obtaining the dynamic identity data), the identity management system 120 may set the digital user account to a first level. Subsequently, in another iteration, the identity management system 120 may increase the level of the digital user account to a second or subsequent level such that the user 102 is able to access additional services. As such, the identity management system 120 may include and/or be associated with a database that stores a plurality of digital account information that are in an array form. The digital account information may include a level associated with the user 102, which may be upgraded based on further iterations of performing process 300 and/or event sequence 400.

The above example of the levels and the corresponding services provided to the user 102 is merely exemplary. For instance, in another example, the levels (e.g., the levels of assurance) may include a first level (e.g., “Level-0”), a second level (e.g., “Level-1”), and a third level (e.g., “Level-2”). For the first level, the user 102 may be able to access personalized marketing promotions. For the second level, the user 102 may be able to place front store orders and/or pay bills without being able to access protected health information (PHI). For the third level, the user 102 may be able to refill prescriptions, check drug costs, view deductibles, and/or pay bills. The dynamic factors may be used (e.g., based on performing any iteration of process 300 and/or event sequence 400) to elevate from the first level to the second level and/or from the second level to the third level. For instance, at block 304 from FIG. 3 and/or block 408 from FIG. 4, the identity management system 120 may determine calculated risk metrics based on the level. Subsequently, at block 306 and/or block 410, the generated dynamic identity data request may be based on the level. For instance, based on the user 102 being at the first level, the generated dynamic identity request may request that the user 102 verify that the user device 104 is trusted and/or provide the date-of-birth of the user 102. Based on the dynamic identity data, the identity management system 120 may not only authorize the user 102, but also increase the level associated with the user 102 (e.g., from the first level to the second level). As such, the user 102 may be able to access additional services such as placing front store orders. Similarly, in another iteration, the generated dynamic identity data request may request that the user 102 provide dynamic identity data such as a prescription label, insurance card, a driver's license, and/or answers to an identity quiz. Based on the dynamic identity data, the identity management system 120 may authorize the user 102 and further increase the level associated with the user 102 (e.g., from the second level to the third level) such that the user 102 may access additional services such as refill prescriptions and/or view deductibles.

In some examples, the identity management system 120 may create a data structure for a new digital account for the user. The identity management system 120 may then populate the created data structure based on the digital account information. For instance, the identity management system 120 may include information indicating the identity of the user 102 and/or other information such as the level of service that the user 102 may be allowed to access (e.g., the level that is based on the one or more calculated risk metrics).

At block 420, the identity management system 120 authorizes access to the services based on the level for the digital user account. For example, the user 102 may seek to access a feature and/or service provided by the enterprise organization such as promotions and/or marketing campaigns, and the identity management system 120 may grant access to the feature and/or service. Thus, as described in event sequence 400, the user 102 and/or the user device 104 may be granted access to the feature and/or service without having to provide any additional personal information of the user 102 unless absolutely necessary to perform the service.

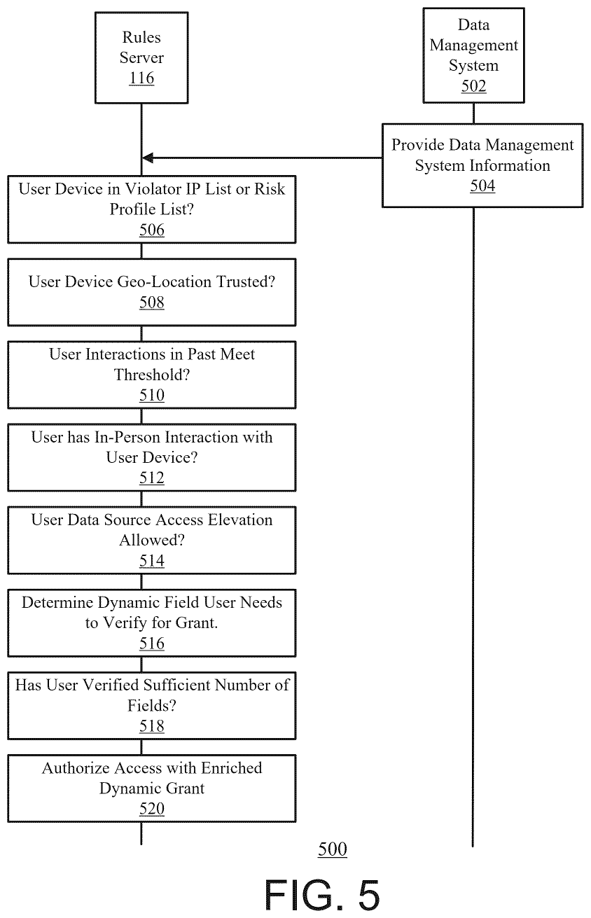

FIG. 5 shows another exemplary event sequence for using rule-based security identification in accordance with one or more examples of the present application. The event sequence 500 includes processes, functions, and/or steps performed by the user device 104 and a data management system 502 (e.g., the internal data management system 122 and/or the external data management system 112). For instance, the event sequence 500 describes a non-limiting example of performing one or more blocks of process 300 and/or event sequence 400.

For example, to determine the calculated risk metrics (e.g., blocks 304 and/or 408), the rules server 116 may provide a request for the data management system information. At block 504, the data management system 502 may respond and provide the data management system information to the rules server 116.

Subsequently, the rules server 116 may perform blocks 506-516 to determine the calculated risk metrics and/or generate the dynamic identity data request. For example, at block 506, the rules server 116 determines whether the user device 104 is in a violator internet protocol (IP) list or risk profile list. For instance, the violator IP list and/or risk profile list may indicate users and/or user devices that have higher associated risk. Therefore, if the users and/or user devices are on one of the lists, the rules server 116 might not implement rule-based security identification and event sequence 500 may end.

At block 508, the rules server 116 determines whether the user device 104 is in a geolocation that is trusted. For instance, the rules server 116 may evaluate the current interaction characteristic of the user's geolocation and determine whether the user's geolocation is within an allowed area (e.g., within the United States). In other words, the rule server 116 may determine the geolocation of the user device 104 and compare the geolocation of the user device 104 with geolocations that are allowed.

At block 510, the rules server 116 determines whether the user interactions in the past meet the threshold. For instance, the rules server 116 may evaluate the prior interaction characteristics (e.g., number of interactions that the user 102 has had with the enterprise organization and/or the type of the interactions), and match the prior interaction characteristics with a value (e.g., the calculated risk metric) based on comparing the prior interaction characteristics with a threshold. The rules server 116 may determine the risk profile based on the value.

At block 512, the rules server 116 determines whether the user has an in-person interaction with user device 104. For instance, the rules server 116 may evaluate the prior interaction characteristics such as the number of in-person interactions that the user 102 has had with the enterprise organization to determine the risk profile.

At block 514, the rules server 116 determines whether the user data source access elevation is allowed. For instance, the rules server 116 may gather information on the prior interactions and determine the list of interactions associated with the enterprise organization. Based on gathering the information and the list of interactions, the rules server 116 may determine whether an access elevation is allowed and/or restricted (e.g., the user 102 may have interacted with a local store and is trying to engage digitally to view health spending information, which may be restricted).

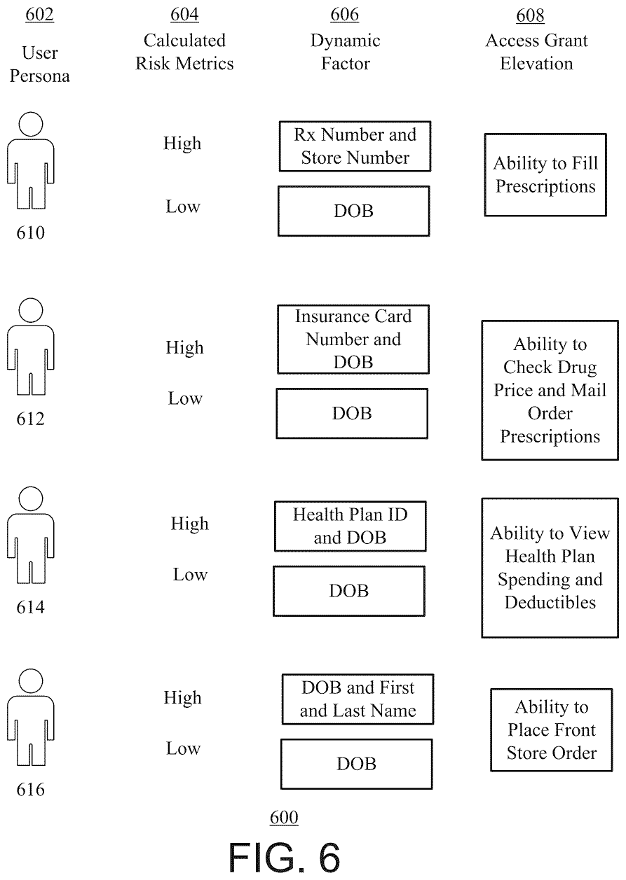

At block 516, the rules server 116 determines the dynamic fields the user 102 needs to verify for grant. For instance, the rules server 116 may determine the dynamic fields for the second factor as described in FIG. 6 below.

After receiving the dynamic identity data from the user device 104, the rules server 116 may perform blocks 518 and 520. For instance, the rules server 116 may determine whether the user 102 has verified a sufficient number of fields. For example, the dynamic identity data request may request the user 102 to provide multiple different fields of information. If the user 102 has provided a sufficient number of fields, the rules server 116 may determine that the user 102 has verified a sufficient number of fields, and proceed to block 520. Otherwise, the rules server 116 may determine that the user 102 has not filled a sufficient number of fields, and might not grant access to the user 102.

At block 520, based on the user 102 verifying a sufficient number of fields, the rules server 116 authorizes access with enriched dynamic grant. For instance, the rules server 116 permits access for the user 102 and/or the user device 104 to access one or more services and/or features provided by the enterprise organization.

FIG. 6 shows exemplary scenarios of using the rule-based security identification in accordance with one or more examples of the present application. For example, the exemplary scenarios 600 include scenarios 610-616. Each scenario 610-616 includes different aspects 602-608 (e.g., user persona 602, calculated risk metrics 604, dynamic factor 606, and access grant elevation 608).

For example, scenario 610 includes a user persona 602 of a retail user 102 with a prescription (Rx). The calculated risk metrics 604 include high and low. The dynamic factors (e.g., dynamic identity data request) 606 are based on the calculated risk metrics 604 and include either an Rx number and/or store number. The access grant elevation 608 includes the ability to fill prescriptions.

Scenario 612 includes a user persona 602 of a Pharmacy Benefit Manager (PBM) member 102. The calculated risk metrics 604 include high and low. The dynamic factors (e.g., dynamic identity data request) 606 are based on the calculated risk metrics 604 and include either an insurance card number and date of birth or a date of birth. The access grant elevation 608 includes the ability to check drug prices and/or mail order prescriptions.

Scenario 614 includes a user persona 602 of a user 102 with a health plan. The calculated risk metrics 604 include high and low. The dynamic factors (e.g., dynamic identity data request) 606 are based on the calculated risk metrics 604 and include either a health plan identifier (ID) and date of birth or a date of birth. The access grant elevation 608 includes the ability to view health plan spending and deductibles.

Scenario 616 includes a user persona 602 of a user 102 that is part of a credit report data (e.g., business associate feeds). The calculated risk metrics 604 include high and low. The dynamic factors (e.g., dynamic identity data request) 606 are based on the calculated risk metrics 604 and include either a date of birth and first and last name or a date of birth. The access grant elevation 608 includes the ability to place front store orders.

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A method, comprising:
receiving, from a user device, user information comprising one or more identifiers associated with a user, wherein the one or more identifiers indicates a phone number associated with the user device;
based on the user information, querying an internal data management system to determine first previous interactions between an enterprise organization and the user;
based on the user information, querying an external data management system to determine second previous interactions between a third party and the user;
determining one or more calculated risk metrics associated with the user based on comparing the first previous interactions and the second previous interactions with one or more thresholds;
generating a dynamic identity data request for the user based on the one or more calculated risk metrics;
in response to providing the dynamic identity data request to the user device, receiving, from the user device, dynamic identity data for the user;
based on the dynamic identity data, creating a data structure for a new digital account for the user;
populating a plurality of entries for the user within the created data structure based on the user information and the one or more calculated risk metrics, wherein a first entry, of the plurality of entries, indicates a level for the user that is based on the one or more calculated risk metrics; and
authorizing the user access to one or more services based on the level for the user that is within the created data structure.

2. The method of claim 1, wherein querying the internal data management system to determine the first previous interactions between the enterprise organization and the user comprises:
providing a query to the internal data management system, wherein the query indicates the user information associated with the user; and
in response to providing the query, receiving, from the internal data management system, data management system information indicating the first previous interactions between the enterprise organization and the user.

3. The method of claim 1, wherein querying the external data management system to determine the second previous interactions between the third party and the user comprises:
providing a query to the external data management system, wherein the query indicates the user information associated with the user; and
in response to providing the query, receiving, from the external data management system, data management system information indicating the second previous interactions between the third party and the user.

4. The method of claim 1, wherein determining the one or more calculated risk metrics comprises:
aggregating the first previous interactions and the second previous interactions to determine aggregated interactions of the user; and
comparing the aggregated interactions of the user with the one or more thresholds to determine a risk profile for the user, wherein generating the dynamic identity data request is based on the determined risk profile.

5. The method of claim 4, wherein aggregating the first previous interactions and the second previous interactions comprises:
applying one or more weights to the first previous interactions and the second previous interactions; and
determining the aggregated interactions of the user based on applying the one or more weights.

6. The method of claim 5, wherein the first previous interactions are associated with a prescription pick-up interaction and the second previous interactions are associated with a financial interaction, and wherein applying the one or more weights comprises applying a first weight to the first previous interactions and a second weight to the second previous interactions, wherein the first weight and the second weight are different.

7. The method of claim 1, wherein determining the one or more calculated risk metrics comprises:
determining current interaction characteristics based on the user information; and
determining a risk profile for the user based on the current interaction characteristics and comparing the first previous interactions and the second previous interactions with the one or more thresholds, and wherein generating the dynamic identity data request is based on the risk profile.

8. The method of claim 7, wherein determining the current interaction characteristics comprises:
determining a geolocation of the user device based on the user information; and
determining whether the geolocation of the user device is in a trusted area, and wherein determining the risk profile for the user is based on whether the geolocation of the user device is in the trusted area.

9. The method of claim 7, wherein determining the current interaction characteristics comprises:
based on the user information, determining whether the user device and/or the user is on a violator list or a risk profile list, and wherein determining the risk profile for the user is based on whether the user device and/or the user is on the violator list or the risk profile list.

10. The method of claim 1, wherein the one or more calculated risk metrics indicates a first risk profile, and wherein generating the dynamic identity data request comprises:
based on the first risk profile, generating the dynamic identity data request requesting for a prescription number and store number of a previously filled prescription for the user, wherein the dynamic identity data for the user indicates the prescription number and the store number, and wherein granting the user access to the one or more services comprises granting the user the ability to fill prescriptions based on the prescription number and the store number indicated by the dynamic identity data.

11. The method of claim 1, wherein the one or more calculated risk metrics indicates a first risk profile, and wherein generating the dynamic identity data request comprises:
based on the first risk profile, generating the dynamic identity data request requesting for an insurance card number of the user and a date-of-birth of the user, wherein the dynamic identity data for the user indicates the insurance card number and the date-of-birth, and wherein granting the user access to the one or more services comprises granting the user the ability to check a drug price and mail order prescriptions based on the insurance card number and the date-of-birth indicated by the dynamic identity data.

12. The method of claim 1, wherein the one or more calculated risk metrics indicates a first risk profile, and wherein generating the dynamic identity data request comprises:
based on the first risk profile, generating the dynamic identity data request requesting for a health plan identifier of the user and a date-of-birth of the user, wherein the dynamic identity data for the user indicates the health plan identifier and the date-of-birth, and wherein granting the user access to the one or more services comprises granting the user the ability to view health plan spending and deductibles based on the health plan identifier and the date-of-birth indicated by the dynamic identity data.

13. The method of claim 1, wherein the one or more calculated risk metrics indicates a first risk profile, and wherein generating the dynamic identity data request comprises:
based on the first risk profile, generating the dynamic identity data request requesting for a first and last name of the user and a date-of-birth of the user, wherein the dynamic identity data for the user indicates the first and last name and the date-of-birth, and wherein granting the user access to the one or more services comprises granting the user the ability to place a mobile order based on the first and last name and the date-of-birth indicated by the dynamic identity data.

14. An enterprise computing platform comprising:
one or more processors; and
a non-transitory computer-readable medium having processor-executable instructions stored thereon, wherein the processor-executable instructions, when executed by the one or more processors, facilitate:
receiving, from a user device, user information comprising one or more identifiers associated with a user, wherein the one or more identifiers indicates a phone number associated with the user device;
based on the user information, querying an internal data management system to determine first previous interactions between an enterprise organization and the user;
based on the user information, querying an external data management system to determine second previous interactions between a third party and the user;
determining one or more calculated risk metrics associated with the user based on comparing the first previous interactions and the second previous interactions with one or more thresholds;
generating a dynamic identity data request for the user based on the one or more calculated risk metrics;
in response to providing the dynamic identity data request to the user device, receiving, from the user device, dynamic identity data for the user;
based on the dynamic identity data, creating a data structure for a new digital account for the user;
populating a plurality of entries for the user within the created data structure based on the user information and the one or more calculated risk metrics, wherein a first entry, of the plurality of entries, indicates a level for the user that is based on the one or more calculated risk metrics; and
authorizing the user access to one or more services based on the level for the user that is within the created data structure.

15. The enterprise computing platform of claim 14, wherein querying the internal data management system to determine the first previous interactions between the enterprise organization and the user comprises:
providing a query to the internal data management system, wherein the query indicates the user information associated with the user; and
in response to providing the query, receiving, from the internal data management system, data management system information indicating the first previous interactions between the enterprise organization and the user.

16. The enterprise computing platform of claim 14, wherein querying the external data management system to determine the second previous interactions between the third party and the user comprises:
providing a query to the external data management system, wherein the query indicates the user information associated with the user; and
in response to providing the query, receiving, from the external data management system, data management system information indicating the second previous interactions between the third party and the user.

17. The enterprise computing platform of claim 14, wherein determining the one or more calculated risk metrics comprises:
aggregating the first previous interactions and the second previous interactions to determine aggregated interactions of the user; and
comparing the aggregated interactions of the user with the one or more thresholds to determine a risk profile for the user, wherein generating the dynamic identity data request is based on the determined risk profile.

18. The enterprise computing platform of claim 17, wherein aggregating the first previous interactions and the second previous interactions comprises:
applying one or more weights to the first previous interactions and the second previous interactions; and
determining the aggregated interactions of the user based on applying the one or more weights.

19. The enterprise computing platform of claim 18, wherein the first previous interactions are associated with a prescription pick-up interaction and the second previous interactions are associated with a financial interaction, and wherein applying the one or more weights comprises applying a first weight to the first previous interactions and a second weight to the second previous interactions, wherein the first weight and the second weight are different.

20. A non-transitory computer-readable medium having processor-executable instructions stored thereon, wherein the processor-executable instructions, when executed, facilitate:
receiving, from a user device, user information comprising one or more identifiers associated with a user, wherein the one or more identifiers indicates a phone number associated with the user device;
based on the user information, querying an internal data management system to determine first previous interactions between an enterprise organization and the user;
based on the user information, querying an external data management system to determine second previous interactions between a third party and the user;
determining one or more calculated risk metrics associated with the user based on comparing the first previous interactions and the second previous interactions with one or more thresholds;
generating a dynamic identity data request for the user based on the one or more calculated risk metrics;
in response to providing the dynamic identity data request to the user device, receiving, from the user device, dynamic identity data for the user;
based on the dynamic identity data, creating a data structure for a new digital account for the user;
populating a plurality of entries for the user within the created data structure based on the user information and the one or more calculated risk metrics, wherein a first entry, of the plurality of entries, indicates a level for the user that is based on the one or more calculated risk metrics; and
authorizing the user access to one or more services based on the level for the user that is within the created data structure.
